(19) United States
(12) Patent Application Publication
(10) Pub. No.: US 2025/0196528 A1
(43) Pub. Date: Jun. 19, 2025

(54) Method, Product, and Kit, Glued Eraser Tips, or Glued Eraser Attachments to Pencils and Writing Instruments

(71) Applicant: Ella Delores Davis, Quitman, LA (US)

(72) Inventor: Ella Delores Davis, Quitman, LA (US)

(21) Appl. No.: 18/973,856

(22) Filed: Dec. 9, 2024

Related U.S. Application Data
(60) Provisional application No. 63/610,963, filed on Dec. 15, 2023.

(51) Int. Cl. B43L 19/00

(52) U.S. Cl. CPC B43L 19/0087

(57) ABSTRACT

This invention is novel in that it is a new invention for making glued eraser tips or glued eraser attachments. The process for making this invention includes applying glue to the inside of an eraser tip or eraser attachment, then attaching this glued eraser tip or glued eraser attachment to the ferrule/head of the pencil, and then waiting at least 15 minutes or the desired time for this attachment to dry. This product can be sold individually or in kit forms. The product can be sold individually by placing pre-applied glue inside of eraser tips and packaging them. The product can be sold in kit form by having pre-applied glue applied inside the eraser tip and include pencils in the kit; while the other kit form includes providing eraser tips, pencils, and glue for the user to apply the glue inside the eraser tip in the kit.

### CROSS-REFERENCE TO RELATED APPLICATIONS

This application claims the benefit of Provisional Patent Application Ser. No. 63/610,963 filed Dec. 15, 2023, by present inventor, Ella Delores Davis.

### BACKGROUND OF INVENTION

The field of the art for which this invention pertains are the fields of education & business.

Pencils/writing instruments/apparatuses have been in existence as early as the 16^{th} century. They have been used as forms of communicating through print. These writing tools are necessary and important for use by anyone, but are particularly important for early learners/users as well. As a result of consistent use of pencils/writing instruments/apparatuses, many times a large part of the tool is left and the tool can still be used, but the eraser is totally gone. Pencils/writing instruments/apparatuses where the eraser tip or eraser attachment is simply placed on top of an existing tool can be problematic for students and users of any age. Those known problems include:
The current eraser tips or eraser attachments that are on the market now will not consistently stay on the ferrule/head of the pencil when using the eraser tip or eraser attachment to erase.
Users have to continuously reapply the eraser tip or eraser attachment when the eraser is being used because it is not firmly attached to the ferrule/head of the pencil.

Consumers also have the option to purchase eraser blocks, etc. that are sold separately and not attached in any way to the pencil, writing instrument, or apparatus. Using an eraser this way presents another problem for the user in that the user has to continuously switch back and forth when using an eraser block, etc. that is not attached to the ferrule/head of a pencil.

### BRIEF SUMMARY OF THE INVENTION

Millions of pencils/writing instruments/apparatuses are thrown away or not used because the eraser has been fully used on the pencil, yet much of the body of the tool remains. Additionally, when users try to use eraser tips or eraser attachments that are currently produced through the market, the user is constantly placing the eraser tip or eraser attachment on the eraser when the eraser is being used. Erasers that are sold separately pose another problem for users in that users have to switch back and forth from the pencil to the eraser when working.

A brief summary of the invention includes comments concerning the invention as a method, kit, and product. As a method, the user places glue inside of an eraser tip or eraser attachment, then places the glued eraser tip or glued eraser attachment on the ferrule/head of the pencil for at least 15 minutes or until it has attached firmly to the pencil. This method can be applicable in kit form as well with pencils, eraser tips, and glue being provided in the kit for the user. Another form of the product, Glued Eraser Tips or Glued Eraser Attachments in kit form is when the manufacturer supplies the pre-applied glued eraser tips or pre-applied glued eraser attachments and pencils. Glued eraser tips or glued eraser attachments can be produced in package form as a single product with the manufacturer applying pre-applied glue inside eraser tips or pre-applied glue inside the eraser attachments.

### BRIEF DESCRIPTION OF VIEWS OF THE DRAWING

### (If any) a Description of the Views by Specifying the Numbers of the Figures

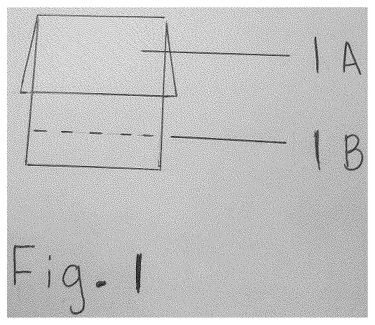

FIG. 1 is a front view of eraser tip or eraser attachment to pencils/writing instruments/apparatuses with pre-applied glue.

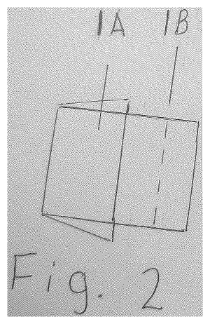

FIG. 2 is a side view of eraser tip or eraser attachment to pencils/writing instruments/apparatuses with pre-applied glue.

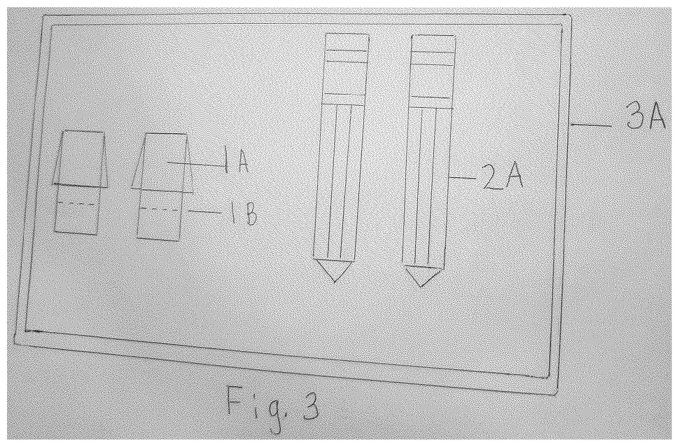

FIG. 3 is picture of a kit consisting of pre-applied glue to eraser tips or pre-applied glue to eraser attachments and pencils.

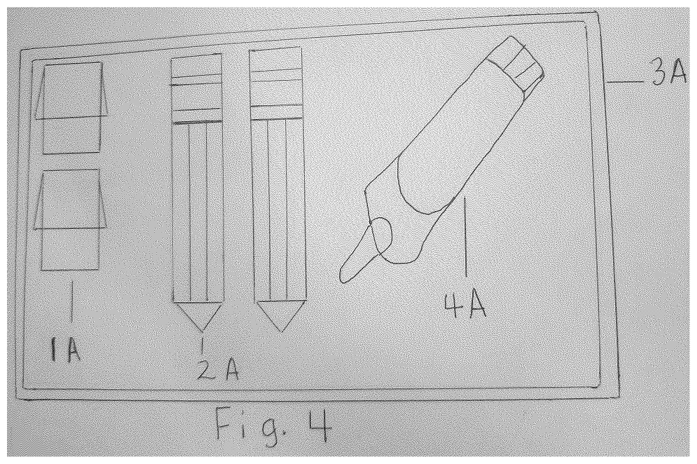

FIG. 4 is picture of a kit consisting of eraser tips or eraser attachments, pencils, and glue.

### DETAILED DESCRIPTION OF THE INVENTION

Pencils can still be used that have much of the body remaining, yet the eraser is gone. The choices for continuing to use the pencil are to use the pencil without an eraser, attach an eraser tip that is currently sold for pencils, or use a separate block eraser that is currently produced. I am proposing that the most efficient way for the user to get continued and effective use of the pencil without an eraser is to attach a glued eraser tip or glued eraser attachment to the ferrule/head of the pencil.

A detail description of the invention would be placing cyanoacrylate, diphenylmethane diisocyanate, polyepoxides, or acetoxy silicone sealant/glue inside of an eraser tip or eraser attachment, then placing the tip or eraser attachment on the ferrule/head of a pencil/writing instrument/apparatus where the eraser has been used. Allow 15 minutes or your desired time for the glued eraser tip or glued eraser attachment to dry on the ferrule/head of the pencil.

This product can be sold in several versions, individually or in kit forms. One version including selling the eraser tips or eraser attachments only with pre-applied glue from the manufacturer inside the eraser tip or eraser attachment. Other versions of this invention includes selling in kit forms. One kit could be having the manufacturer pre-apply the glue inside the eraser tip or eraser attachment with pencils and package the product. Another version of a kit would be having the consumer applying the glue inside the eraser tip or eraser attachment in the kit which would include eraser tips or eraser attachments, pencils, and glue.

The types of glue that can be used for this process varies. The types of glue to consider include cyanoacrylate, diphenylmethane diisocyanate, polyepoxides, or acetoxy silicone sealant.

Buyers will get the full use of the body of their pencil because a glued eraser tip or glued eraser attachment can consistently be added when any part of the body pencil/writing instrument/apparatus is left. The glued eraser tip or glued eraser attachment will stay on the ferrule/head of the pencil allowing the user to use the glued eraser tip or glued eraser attachment with ease and without having to constantly reapply it to the ferrule/head of the pencil. Also, the user will not have to constantly switch back and forth from pencil to eraser when a pencil and eraser blocks, etc. are used separately.

To further provide information concerning a detailed description of the invention, additional details will be provided concerning the drawings. FIG. 1 is a front view of an eraser tip or eraser attachment (1A) with pre-applied glue (1B) inside. FIG. 2 is a side view of eraser tip or eraser attachment (1A) with pre-applied glue (1B) inside. FIG. 3 is a front view of eraser tips or eraser attachments (1A) with pre-applied glue inside (1B), pencils (2A), and kit (3A). FIG. 4 is a front view of eraser tips or eraser attachments (1A), pencils (2A), kit (3A), and glue (4A).

I claim:

1. A method of comprising the steps of:
providing a package with an eraser tip or eraser attachment with pre-applied glue by a manufacturer:
attaching said eraser tip or eraser attachment to a ferrule/or head of a pencil/or writing instrument.

2. The method according to claim 1 wherein the glue is cyanoacrylate.

3. The method according to claim 1 wherein the glue is diphenylmethane diisocyanate.

4. The method according to claim 1 wherein the glue is polyepoxides.

5. The method according to claim 1 wherein the glue is an acetoxy silicone sealant.

6. The method according to claim 1, where in the package further comprises pencils.

7. A kit comprising
a package,
wherein said package comprises
at least one pencil,
at least one eraser tip or eraser attachment, and
a container of glue;
wherein said kit is configured for applying glue to the at least one eraser tip or eraser attachment; and attaching the at least one eraser tip or eraser attachment to a ferrule/or head of the at least one pencil.

8. The kit of according to claim 7, further comprising additional eraser tips or eraser attachments, pencils, and containers of glue.

9. The kit according to claim 7, wherein the glue is cyanoacrylate.

10. The kit according to claim 7, wherein the glue is diphenylmethane diisocyanate.

11. The kit according to claim 7, wherein the glue is polyepoxides.

12. The kit according to claim 7, wherein the glue is an acetoxy silicone sealant.

13. A product comprising of:
an eraser tip with cavity
with pre-applied glue.

14. A product according to claim 13, where in the glue is cyanoacrylate.

15. A product according to claim 13, wherein the glue is diphenylmethane diisocyanate.

16. A product according to claim 13, wherein the glue is polyepoxides.

17. A product according to claim 13, wherein the glue is acetoxy silicone sealant.
